(19) United States
(12) Patent Application Publication
(10) Pub. No.: US 2025/0372283 A1
(43) Pub. Date: Dec. 4, 2025

(54) ACID RESISTANT WIRELINE CABLE

(71) Applicant: Schlumberger Technology Corporation, Sugar Land, TX (US)

(72) Inventors: Joseph Varkey, Sugar Land, TX (US); Maria Grisanti, Sugar Land, TX (US); David Kim, Sugar Land, TX (US); Sheng Chang, Sugar Land, TX (US); Antonio Mauricio Cevallos Navarrete, Sugar Land, TX (US); Jared Mangum, Sugar Land, TX (US); Ramadan Mansour, Pearland, TX (US); Tam Tran, Sugar Land, TX (US)

(21) Appl. No.: 19/208,079

(22) Filed: May 14, 2025

Related U.S. Application Data
(60) Provisional application No. 63/652,783, filed on May 29, 2024.

(51) Int. Cl. H01B 7/22; E21B 17/00; H01B 7/28

(52) U.S. Cl. CPC H01B 7/22; E21B 17/003; H01B 7/2806

(57) ABSTRACT

The present disclosure relates to an armor packaging for a cable comprising an inner armor layer and an outer armor layer, the inner armor layer and the outer armor layer formed by armor wires made from an alloy material with high acid resistance. The alloy material may, for example, be selected from the group of Inconel 625, Inconel 825, Incoloy 27-7MO, HC265, C-276, and MP35N. In addition, the cable may include an acid isolation polymer layer disposed radially between the inner armor layer and an outer armor layer of the armor packaging.

### CROSS-REFERENCE TO RELATED APPLICATION

This application claims priority to and the benefit of U.S. Provisional Patent Application Ser. No. 63/652,783, entitled “ACID RESISTANT WIRELINE CABLE,” filed May 29, 2024, which is hereby incorporated by reference in its entirety for all purposes.

### BACKGROUND

The present disclosure generally relates to acid resistant downhole cables.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admission of prior art.

Well acidizing is a production stimulation technique employed to improve production of a well that exhibits low permeability, or to encourage permeability and flow from an already producing well that has become under-productive. In this technique, acid with relatively high concentration such as high sulfuric acid and hydrochloric acid may be pumped into the wells to dissolve downhole limestone, dolomites, or calcite cement.

Due to the relatively high acidity of the acid used, conventionally used downhole cables armored with galvanized improved plow steel (GIPS) or HC265 may not be able to withstand the acidic environment when well acidizing is being carried out, thereby resulting in corrosion of the cables, which may cause further damage to downhole systems.

While there are currently downhole cables with relatively high nickel and relatively high cobalt content alloy armor, they tend to be significantly more expensive than conventional armored cables. To reduce cost, there are instances where armored cables known to be incompatible with such operations are used by sacrificing the cable life. Therefore, there is an incentive for an improved armor packaging for downhole cables that alleviates the above issues.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The embodiments described herein also include a wireline cable that includes an armor packaging having an inner armor layer and an outer armor layer. The outer armor layer is formed by armor wires made from alloy materials with higher acid resistance than armor wires of the inner armor layer. The armor packaging also includes an acid isolation polymer layer disposed radially between the inner armor layer and the outer armor layer.

The embodiments described herein also include a wireline cable that includes an armor packaging having an inner armor layer and an outer armor layer. Inner armor wires forming the inner armor layer and/or outer armor wires forming the outer armor layer are coated with an acidic protective inhibition chemical selected from the group of: organic nitrogen compounds including amines, amides, heterocyclics, and quaternary ammonium salts; and intensifiers including formic acid, iodides, and acid-soluble salts of copper, bismuth, antimony, and mercury with compound groups including alpha hydroxy acetylene, alkenyl phenones, and cinnamaldehyde derivatives.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a well system having a downhole tool deployed downhole within a well extending through one or more formation layers via a cable, such as a wireline cable, in accordance with aspects of the present disclosure;

FIGS. 2A and 2B illustrate embodiments of a cable having an armor packaging, in accordance with aspects of the present disclosure;

FIGS. 3A and 3B illustrate embodiments of a cable having an armor packaging with an outer jacket for a cable, in accordance with aspects of the present disclosure;

FIGS. 4A and 4B illustrate embodiments of a cable having an armor packaging with an outer jacket forming over stranded wires forming an outer armor layer, in accordance with aspects of the present disclosure;

FIGS. 5A and 5B illustrate embodiments of a cable having an armor packaging with an outer jacket forming over a shaped outer armor layer, in accordance with aspects of the present disclosure;

FIGS. 6A and 6B illustrate embodiments of a cable having an armor packaging with an intermediate jacket layer between a less acid resistant inner armor layer and a more acid resistant outer armor layer, and an outer jacket formed over the outer armor layer, in accordance with aspects of the present disclosure;

FIGS. 7A and 7B illustrate embodiments of a cable having an armor packaging with an intermediate jacket layer between a less acid resistant inner armor layer and a more acid resistant outer armor layer, in accordance with aspects of the present disclosure;

FIGS. 8A through 8C illustrate embodiments of a cable having an armor packaging with cladded armor wires forming an outer armor layer, in accordance with aspects of the present disclosure;

FIGS. 9A through 9C illustrate embodiments of a cable having an armor packaging with cladded armor wires comprising a polymer jacket between the clad metal and the armor wire forming an outer armor layer, in accordance with aspects of the present disclosure;

FIGS. 10A and 10B illustrate embodiments of a cable having an armor packaging with an acid isolation polymer layer disposed radially between a less acid resistant inner armor layer and a more acid resistant outer armor layer of the armor packaging, in accordance with aspects of the present disclosure;

FIGS. 11A and 11B illustrate embodiments of a cable having an armor packaging with an acid isolation polymer layer disposed radially between a less acid resistant inner armor layer and a more acid resistant outer armor layer of the armor packaging having alloy cladded outer armor wires, in accordance with aspects of the present disclosure;

FIGS. 12A and 12B illustrate embodiments of a cable having an armor packaging with an extruded acid isolation polymer layer disposed radially between a less acid resistant inner armor layer and a more acid resistant outer armor layer of the armor packaging, in accordance with aspects of the present disclosure;

FIGS. 13A and 13B illustrate embodiments of a cable having an armor packaging with an extruded acid isolation polymer layer disposed radially between a less acid resistant inner armor layer and a more acid resistant outer armor layer of the armor packaging having alloy cladded outer armor wires, in accordance with aspects of the present disclosure; and

FIGS. 14A and 14B illustrate embodiments of a cable having an armor packaging with an acid isolation polymer layer disposed radially between a less acid resistant inner armor layer and a more acid resistant outer armor layer of the armor packaging and voids between a core of the cable and inner armor wires forming the inner armor layer, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to describe certain embodiments more clearly.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the analysis and control system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

In oilfield applications, there is a need to use different types of acid fluid mixtures with very high acid concentrations such as, but not limited to, high sulfuric acid and hydrochloric acid up to 34% concentrations. Commonly used cable materials such as galvanized improved plow steel (GIPS) or HC265 cannot withstand such acid concentrations. The embodiments described herein include the design and use of possible alloy armor wire materials, combinations of different alloys, combinations of GIPS and alloy, and so forth, in the armor matrix of downhole cables. The embodiments described herein also include suitable use of doped polymer jackets to protect the armor wire from such acid concentrations.

In general, relatively high strength and high nickel and high cobalt content alloy armor wires suitable for acid stimulation and sour well applications such as MP35N, Incoloy 27-7MO, HC625, 25-6MO are significantly more expensive than GIPS armor wires. The armor wire cost directly impacts the cost of a particular downhole cable.

Conventional downhole cables use conventional materials for layers of the cables. This ensures that the cable layers have the same Young's Modulus or Modulus of elasticity, therefore, the various layer materials will experience the same elongation at a given load. However, for applications where acid and sour well conditions are present, the cable price becomes extremely high or the field opts to use a cable with an armor wire known to be incompatible with the operation to save cost by sacrificing the cable life.

As discussed above, the embodiments described herein provide acid resistant downhole cables. For example, the embodiments described herein include an armor packaging for a downhole cable comprising an inner armor layer and an outer armor layer, wherein the outer armor layer is formed by armor wires made from an alloy material with relatively high acid resistance. The alloy material of the outer armor wires may be selected from the group comprising C-276, Inconel 686, Inconel 20, Inconel 625, Inconel 825, Incoloy 27-7MO, HC265, and MP35N alloys.

In addition, the embodiments described herein provide a cable design that consists of a stranded copper conductor at the center that can be filled (e.g., gas-blocked) or not filled. Insulation and a core jacket may be applied over the copper conductor. In certain embodiments, to keep the inner armor wires from getting flooded with acid, as well as to create a shield between the two armor wire layers, a polyether ether ketone (PEEK), Perfluoroalkoxy (PFA), any polyketone, or any other suitable polymer layer may be added to form an acid isolation polymer layer.

The acid isolation polymer layer acts as a physical barrier between the inner and outer armor wires so that if acid surrounds the outer armor wires, it should not be able go deeper into the cable and reach the (e.g., GIPS) inner armor wires. GIPS alone is susceptible to severe damage from acid and well fluids. The outer armor layer of contra-helically applied armor wires has been designed with acid resistance, as further described herein.

As described in greater detail herein, for acid resistance in the armor package design, alloy materials such as Inconel 625, Inconel 825, Incoloy 27-7MO, HC265, C-276, MP35N, or any other suitable alloys having relatively high acid resistance, may be used. To apply such alloy materials, there are generally two outer armor wire designs proposed: (1) GIPS armor wires that are cladded with one or more of these relatively high acid resistant alloy materials, and (2) alloy armor wires composed of the one or more of the relatively high acid resistant alloy materials.

Use of an acid resistant chemical coating can also serve as protection to the zinc on GIPS wires. In certain embodiments, both the inner and outer armor wires may be GIPS with acid resistant chemical coating bonded to the zinc on the armor wires' outer surfaces. However, in other embodiments, only the outer armor wires may be GIPS with acid resistant coating while the inner armor wires are not so coated, in order to reduce cost.

In addition, in certain embodiments, a second Tefzel layer may be put on top of PEEK/PFA/polyketone or any other suitable polymer layer to provide additional acid resistance. In certain embodiments, the outer armor wire layer may be embedded into the second Tefzel jacket and exhibit acid resistance through its material composition. With or without a final jacket coating on the cable's surface, the outer armor wires may be designed to withstand exposure to acid fluids.

In addition, in certain embodiments, the cable may include a smooth jacket or armor interstices filled with polymer. The cable can be deployed in a well where acid is used with produced fluid or water. Furthermore, in certain embodiments, to further protect the cable from acid and produced fluid damage, an acid neutralizing grease may be applied on the cable while pulling out of hole (POOH).

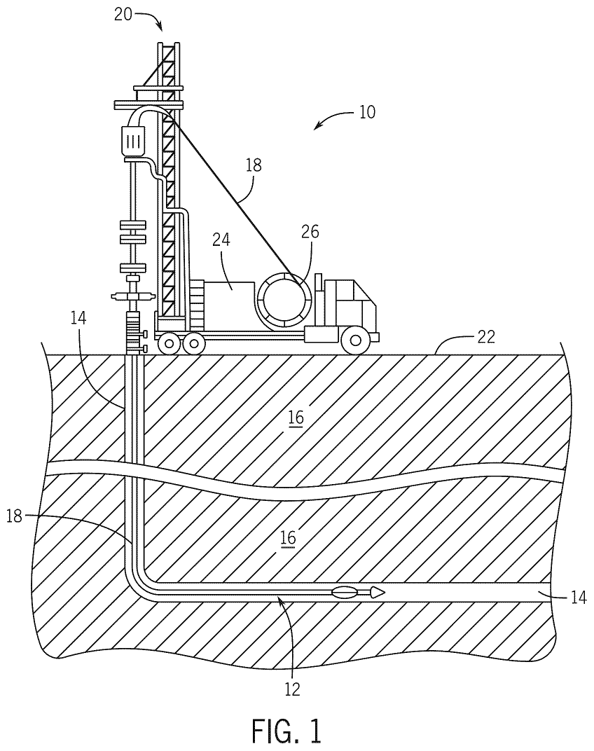

With reference to FIG. 1, a well system 10 may include running a downhole tool 12 downhole within a well 14 extending through one or more formation layers 16 via a cable 18, such as a wireline cable. As illustrated in FIG. 1, surface equipment 20 may be located at a well site 22 to facilitate the conveyance of the downhole tool 12 into the well 14 via the cable 18. For example, in certain embodiments, a control unit 24 may include a reel 26 configured to unspool the cable 18 such that the cable 18 may be delivered into the well 14, thereby conveying the downhole tool 12 into the well 14. Although illustrated in FIG. 1 as being a mobile control unit 24, such as a truck, in other embodiments, the control unit 24 may be installed at the well site 22 in a more permanent manner.

After perforating one or more formation layers 16 of the well system 10, it is sometimes necessary or desired to pump a fluid into well to contact the formation layers 16. One example of such a fluid is an acid used in well acidizing operations. Well acidizing is a term well-known to those skilled in the art of petroleum engineering and includes various techniques such as “acid washing”, “acid fracturing”, and “matrix acidizing”. Acid washing involves the pumping of acid into the well 14 to remove near-well formation damage and other damaging substances. This procedure commonly enhances production by increasing the effective well radius. When performed at pressures above the pressure required to fracture the formation layers 16, the procedure is often referred to as acid fracturing. In acid fracturing operations, flowing acid tends to etch the fracture faces of the formation layers 16 in a non-uniform pattern, thus forming conductive channels that remain open without a propping agent after the fracture closes. Finally, matrix acidizing involves the treatment of a reservoir formation with a stimulation fluid containing a reactive acid. For instance, in sandstone formation layers 16, the acid reacts with the soluble substances in the formation matrix to enlarge the pore spaces, and in carbonate formation layers 16, the acid dissolves the entire formation matrix. In each case, the matrix acidizing treatment improves the formation permeability to enable enhanced production of reservoir fluids. Matrix acidizing operations are ideally performed at high rate, but at treatment pressures below the fracture pressure of the formation. This enables the acid to penetrate the formation layers 16 and extend the depth of treatment while avoiding damage to the formation layers 16. Examples of acids to be used include, but are not limited to, hydrochloric acid, hydrofluoric acid, acetic acid, and formic acid.

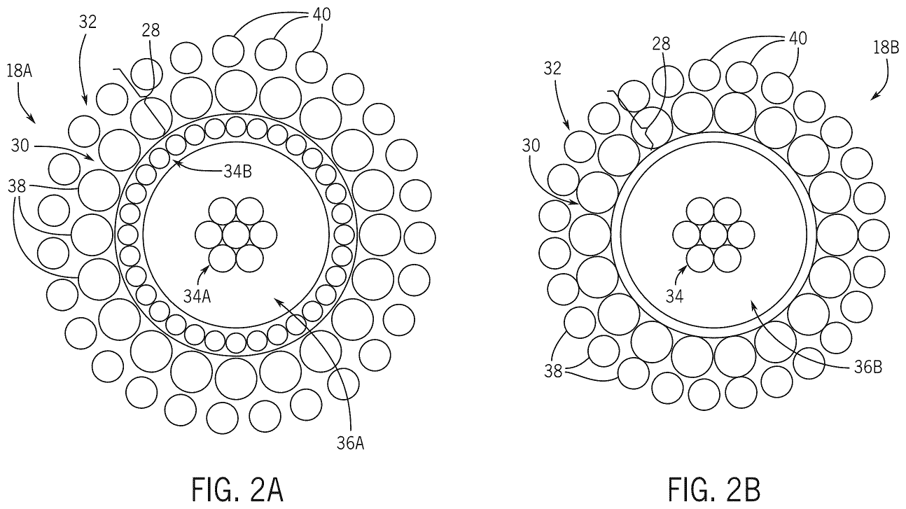

FIGS. 2A and 2B illustrate embodiments of cables 18 having an armor packaging 28 that includes an inner armor layer 30 and an outer armor layer 32. In particular, FIG. 2A illustrates a coaxial (coax) cable 18A having two conductor layers 34A, 34B coaxially disposed within a core 36A of the coax cable 18A around which the armor packaging 28 is disposed, whereas FIG. 2B illustrates a mono cable 18B having a single conductor layer 34 disposed within a core 36B of the mono cable 18B. For example, the coax cable 18A illustrated in FIG. 2A may include a central conductor layer 34A having a plurality of conductor wires bundled (e.g., stranded) together and an outer conductor 34B having a plurality of conductor wires disposed in a circular manner, radially equidistant from a central axis of the coax cable 18, whereas the mono cable 18B illustrated in FIG. 2B may include only a central conductor layer 34 having a plurality of conductor wires bundled together. It will be appreciated that the cores 36A, 36B of the other coax and mono cables 18A, 18B described herein, respectively, may be substantially similar to those illustrated in FIGS. 2A and 2B, respectively.

As illustrated in FIGS. 2A and 2B, in certain embodiments, the inner armor layer 30 of the armor packaging 28 may include a plurality of inner armor wires 38, each comprised of C-276, Inconel 686, and Inconel 20 alloys, and the outer armor layer 32 of the armor packaging 28 may similarly include a plurality of outer armor wires 40, each comprised of C-276, Inconel 686, and Inconel 20 alloys. These alloys are much more resistant to premature degradation when exposed to high acid concentrations than other alloys such as Incoloy 27-7MO, MP35N, or HC625 due to their relatively high nickel content. These alloys are currently not used in downhole cables such as mono, coax, and hepta cables. It should be noted that, although not all cable core options are shown in the figures described herein, the embodiments described herein apply equally to mono, coax, quad, or hepta electrical cable configurations or such configurations containing optical fibers in electrical conductors.

Depending on the concentration of the acid used downhole or other environmental and operational requirements, a combination of alloy materials may be used to form the inner armor layer 30 and the outer armor layer 32 of the armor packaging 28. For example, both the inner armor layer 30 and the outer armor layer 32 of the armor packaging 28 can be made from the same alloy material. Alternatively, as the inner armor layer 30 of the armor packaging 28 is isolated from environmental fluids, a more resistant alloy material may be used for the outer armor layer 32 of the armor packaging 28, while a lesser resistant and lower priced alloy material may be used for the inner armor layer 30 of the armor packaging 28 for cost reduction purposes, in certain embodiments.

Although not illustrated in FIGS. 2A and 2B, in certain embodiments, the armor packaging 28 may further include an outer jacket encompassing (e.g., disposed radially about) the outer armor layer 32 of the armor packaging 28. In certain embodiments, the outer jacket may be a smooth polymer with a thickness between 0.005 inch and 0.100 inch. In such an embodiment, the inner armor layer 30 and the outer armor layer 32 of the armor packaging 28 may be constructed from a material selected from the group comprising C-276, Inconel 686, and Inconel 20 alloys, or ansuch as Incoloy 27-7MO or MP35N.

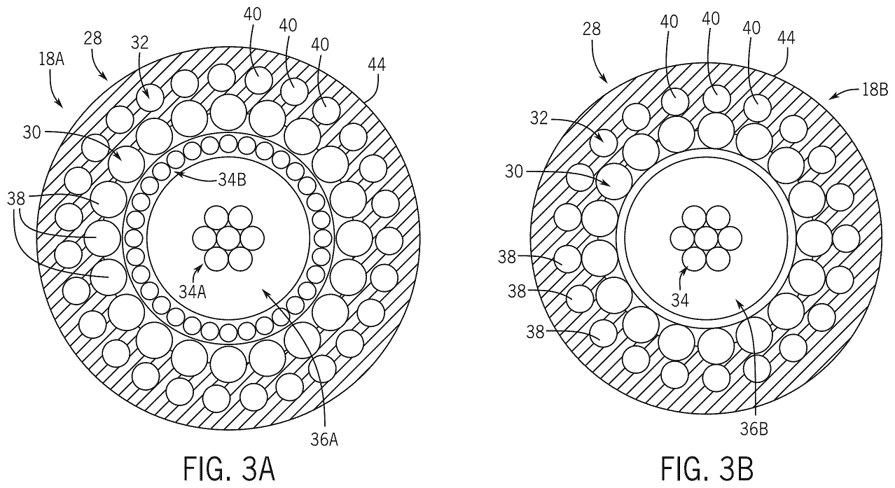

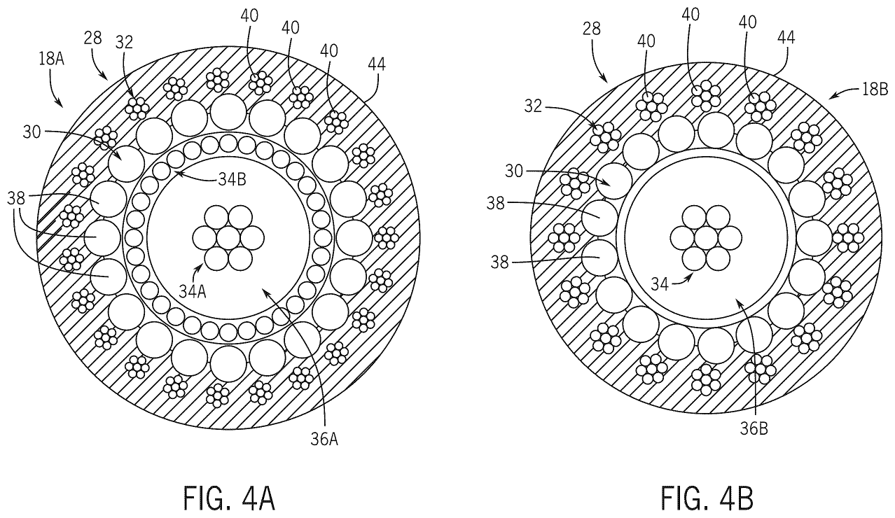

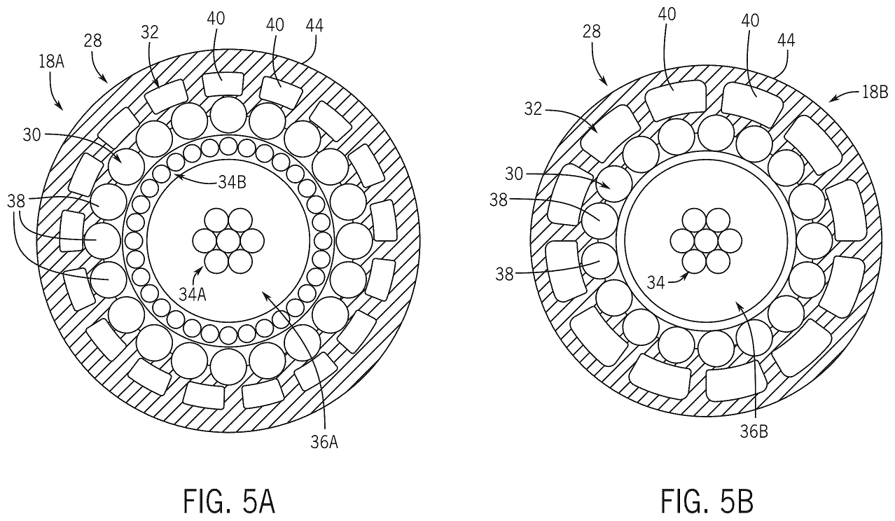

In certain embodiments, the outer armor layer 32 of the armor packaging 28 may include solid, stranded, or shaped outer armor wires 40. FIGS. 3A through 5B illustrate examples of cables 18 with differently shaped outer armor wires 40 of the outer armor layers 32 of the armor packaging 28. For example, FIGS. 3A and 3B illustrate an outer armor layer 32 with a plurality of generally round outer armor wires 40, FIGS. 4A and 4B illustrate an outer armor layer 32 with stranded outer armor wires 40 (e.g., a plurality of armor wire strands bundled together to form the outer armor wires 40), and FIGS. 5A and 5B illustrate an outer armor layer 32 with shaped outer armor wires 40. It will be noted that the shaped outer armor wires 40 illustrated in FIGS. 5A and 5B may be any possible non-round shapes, such as generally rectangular, generally triangular, and so forth, as opposed to the generally round shapes of many of the other embodiments described herein It will be appreciated that the inner armor wires 38 of the inner armor layer 30 may also include various shapes, similar to the embodiments of the outer armor wires 40 that are illustrated in FIGS. 3A through 5B.

For the stranded armor wire embodiments illustrated in FIGS. 4A and 4B, the number of the armor wire strands that form the outer armor wires 40 may be adjusted (e.g., increased or reduced). For example, in certain embodiments, the outer armor wires 40 may have as few as three individual armor wire strands or as many as 19 individual armor wire strands. It will be that any number of individual armor wire strands of the outer armor wires 40 between appreciated these lower and upper numbers of individual armor wire strands may be used. It will also be appreciated that, in certain embodiments, the number of individual armor wire strands of the inner armor wires 38 may be similarly adjusted between similar lower and upper numbers of individual inner armor wires 38.

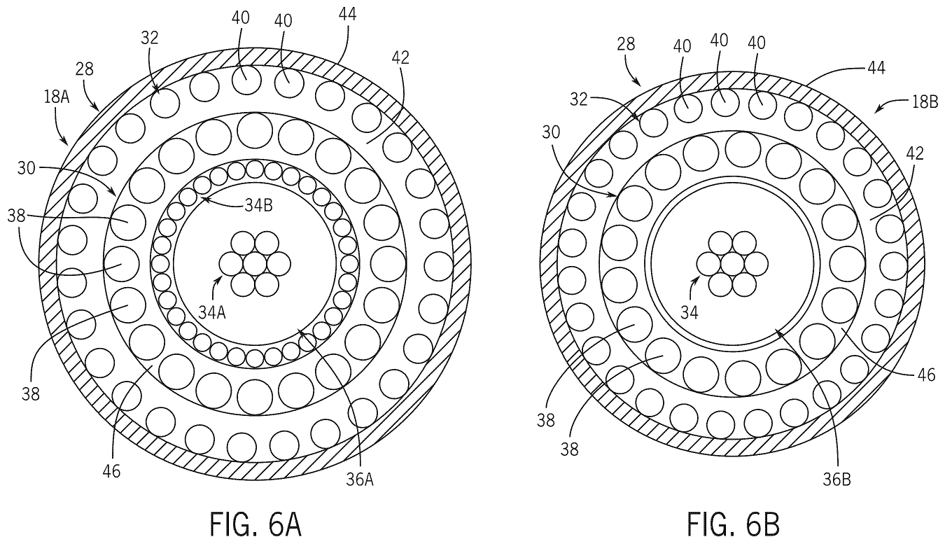

In certain embodiments, the space between inner and outer armor wires 38, 40 may be filled with polymer materials as an intermediate jacket layer 42, and an outer jacket 44 may be extruded and bonded to the intermediate jacket layer 42. An example of these embodiments can be seen in FIGS. 6A and 6B. As illustrated, the cable 18 may include a core jacket 46 within which the inner armor wires 38 are embedded, an intermediate jacket layer 42 between the two armor layers 30, 32, and an outer jacket 44. The outer armor layer 32 is separated and isolated from the inner armor layer 30 by means of the intermediate jacket layer 42. Advantageously, if the outer armor layer 32 of the armor packaging 28 is damaged during field use, the outer armor layer 32 may be exposed to environmental fluid, but the inner armor layer 30 of the armor packaging 28 will be isolated by the intermediate jacket layer 42.

A combination of alloy armor wires materials or GIPS and alloy armor materials may be used in the inner and outer armor layers 30, 32, depending upon the acid concentration, as well as other environmental and operational requirements. For example, both inner and outer armor layers 30, 32 may be made out the same alloy material such as C-276, Inconel 686, Inconel 20, Incoloy 27-7MO, MP35N, among others. Alternatively, as the inner armor wire 38 is isolated from environmental fluids, a more resistant alloy material may be used for the outer armor wire 40 and a lesser resistant and lower price alloy or GIPS material may be used for the inner armor wire 38 for cost reduction purposes. In this cable design, if the outer jacket 44 is cut or damaged during field use, the outer armor wire 40 might be exposed to acid but the inner armor wire 38 may be isolated by the intermediate jacket layer 42. Therefore, for this reason, an alloy armor wire material is preferred for the outer armor layer 32 and a lesser resistant material can be used for the inner armor layer 30.

In addition, in certain embodiments, the outer jacket 44 may be doped with carbon fiber fragments that act as free radical acceptors at above room temperature. This allows the outer jacket 44 to act as a protective barrier when the armor packaging 28 directly contacts acidic chemicals, hence making withstanding acids with higher concentration such as hydrochloric acid, hydrogen sulfide, and sulfuric acid possible. The carbon fiber doping concentration of the outer jacket 44 may be from 3% to a maximum of 15% so that the elongation of the doped outer jacket 44 is greater than 10%.

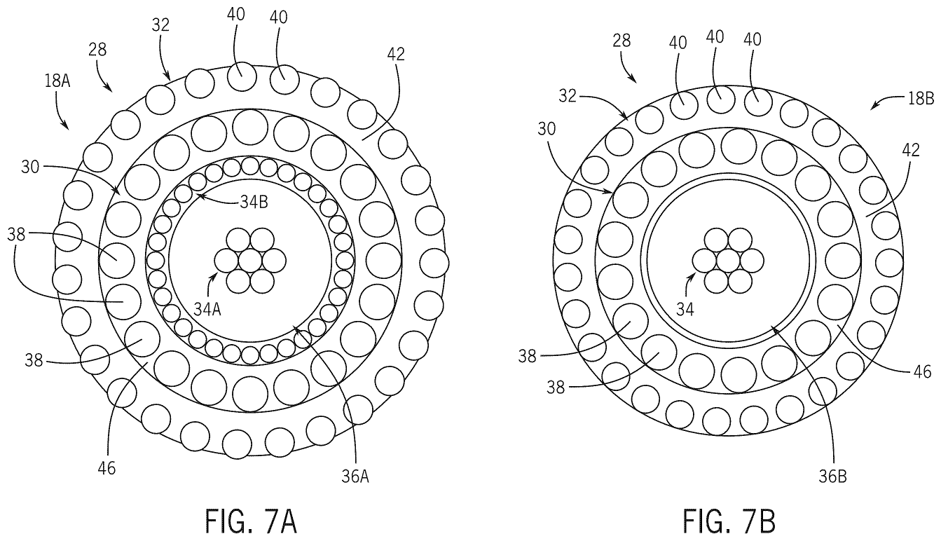

In certain embodiments, the cable 18 may not include an outer jacket 44. Instead, the armor packaging 28 for the cable 18 may comprise an intermediate jacket layer 42 between the inner armor layer 30 and the outer armor layer 32, which isolates the inner armor layer 30 from the outer armor layer 32. Referring to FIGS. 7A and 7B, the space between the outer armor layer 32 and the inner armor layer 30 may be partially filled or fully filled by heating the intermediate jacket layer 42, but maintaining the required separation between the armor layers 30, 32 in order to maintain the isolation between the inner armor layer 30 and the outer armor layer 32. Again, in this embodiment, an outer jacket 44 may not be required.

Similar to the embodiments illustrated in FIGS. 6A and 6B, a combination of alloy armor wires materials or GIPS and alloy armor materials may be used in the inner and outer armor layers 30, 32, depending upon the acid concentration, as well as other environmental and operational requirements. For example, both inner and outer armor layers 30, 32 may be made out the same alloy material such as C-276, Inconel 686, Inconel 20, Incoloy 27-7MO, MP35N, among others. Alternatively, as the inner armor wire 38 is isolated from environmental fluids, a more resistant alloy material may be used for the outer armor wire 40 and a lesser resistant and lower price alloy or GIPS material may be used for the inner armor wires 38 for cost reduction purposes.

In certain embodiments, the armor wires 38, 40 forming the inner armor layer 30 or the outer armor layer 32 of the armor packaging 28 may be cladded with a relatively thin layer of alloy with relatively high acid resistance. This is particularly suitable if the armor wires 40 forming the outer armor layer 32 are made with GIPS or other less acid resistant alloy. In certain embodiments, to lower cost, the armor wires 38 of the inner armor layer 30 may not be cladded with an alloy layer with relatively high acid resistance.

Such embodiments utilize cladding technology processes on a lesser acid resistant armor wire 38, 40. For example, certain embodiments use a relatively high acid resistance thin layer of alloy for cladding to the surface of a GIPS armor wire 38, 40. Two alternatives may be used: a) a relatively high acid resistant alloy cladded directly to the surface of the GIPS armor wire 38, 40, hence protecting the armor wire 38, 40 from the corrosive environment; and b) a relatively thin polymer jacket layer, like Tefzel or any other polymer that is acid resistant, may be extruded over the GIPS armor wire 38, 40 prior to the cladding process. In certain embodiments, a polymer jacket layer extruded over the GIPS armor wire 38, 40 may offer an additional barrier, preventing direct acid contact with the armor wire 38, 40 in the event of pinholes in the cladded material. Afterward, the high acid resistant alloy may be cladded over the extruded GIPS armor wire 38, 40.

In addition, in certain embodiments, a core jacket polymer layer 46, intermediate jacket polymer layer 42, and final outer jacket polymer layer 44 may be extruded during the cable manufacturing processes. In certain embodiments, the inner armor wires 38 (e.g., with no cladding process performed on them) may be embedded into a polymer matrix for protection. Then, cladded outer armor wires 40 may be used for the outer armor pass. If the outer jacket 44 is cut through during field use, the cladded outer armor wires 40 with an acid resistance alloy may prevent acid in direct contact with the outer armor wires 40, hence maintaining wire integrity.

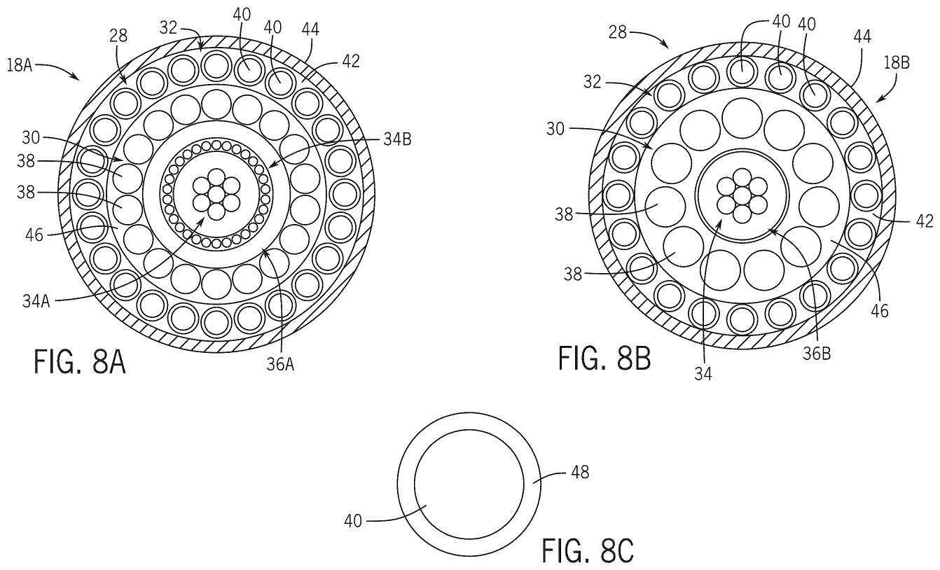

With reference to FIGS. 8A through 8C, an acid resistant clad alloy 48 with relatively high acid resistance may be cladded over each armor wire 40 forming the outer armor layer 32 of the armor packaging 28. In such an embodiment, the armor wires 40 forming the outer armor layer 32 may be made of a less acid resistant material such as GIPS, while the clad alloy 48 may be made of an acid resistant material selected from the group comprising Inconel 625, Inconel 825, Incoloy 27-7MO, HC265, C-276, and MP35N. If the outer jacket 44 of the cable 18 is cut during field operation, the acid resistance alloy 48 cladded on the outer armor wires 40 forming the outer armor layer 32 prevents direct contact of acid with the armor wires 40, hence maintaining wire integrity.

As described in greater detail herein, the acid resistant materials that are used (e.g., for the acid resistant alloy 48 cladded on the outer armor wires 40 and/or the acid resistant material used for the armor wires 38, 40 themselves) may be more acid resistant than other materials commonly used in cables 18 such that the cables 18 described herein will be substantially more acid resistant than conventional cables. For example, as described herein, the acid resistant materials may include, but are not limited to, Inconel 625, Inconel 825, Incoloy 27-7MO, HC265, C-276, and MP35N, each of which has a relatively high acid resistance as compared to other conventional cable materials.

Specifically, each of the acid resistant materials has a relatively high acid resistance, which may be defined by a Pitting Resistance Equivalent Number (PREN). Alloys do not typically have a single quantifiable number specifically for acid resistance. Rather, acid resistance of alloys is usually assessed through standardized tests and material specifications, which provide detailed performance data under specific conditions. These assessments consider factors such as concentration, temperature, and type of acid. However, the PREN number is a calculated value used to predict the resistance of stainless steels and other alloys to pitting corrosion, particularly in chloride-containing environments. Table 1 illustrates example PREN number for the alloy materials described herein, to illustrate their relatively high acid resistance values.

| Alloy | PREN |
|---|---|
| Inconel 625 | 51.7 |
| Inconel 825 | 31.0 |
| Incoloy 27-7MO | 56.0 |
| HC265 | 47.0 |
| C-276 | 74.9 |
| MP35N | 53.0 |

As such, it will be appreciated that the alloy materials described herein all have a relatively high PREN number denoting that they all have a relatively high acid resistance level. For example, in certain embodiments, all of the acid resistant alloy materials described herein may have a PREN number of greater than 30.0, greater than 35.0, greater than 40.0, greater than 45.0, greater than 50.0, or even greater.

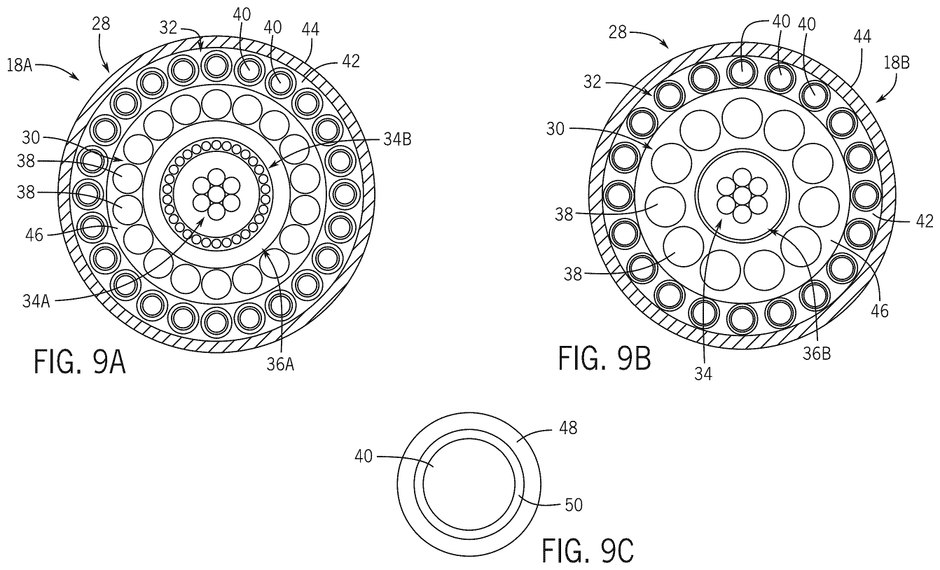

With reference to FIGS. 9A through 9C, the acid resistant clad alloy 48 with relatively high acid resistance may be cladded over a polymer jacket layer 50 covering each armor wire 40 forming the outer armor layer 32 of the armor packaging 28. The polymer jacket layer 50 may be an acid resistant polymer material such as Tefzel, while the clad alloy 48 may be made of an acid resistant material selected from the group comprising Inconel 625, Inconel 825, Incoloy 27-7MO, HC265, C-276, and MP35N, and the armor wires 40 forming the outer armor layer 32 may be made of a less acid resistant material such as GIPS. The polymer jacket layer 50 offers an additional barrier in preventing direct contact between acid and the outer armor layer 32 in the event of pin holes forming in the cladded alloy 48.

The cladding embodiments illustrated in FIGS. 8A through 9C may be formed using a cladding process where a smooth high acid resistance alloy, like C-276, Inconel 20, Inconel 686, or MP35N with a thickness from between 0.001 inch to 0.010 inch may cladded: a) directly to the metal surface of the GIPS armor wire 40, hence protecting of the acid environment (e.g., FIGS. 8A through 8C); or b) to the GIPS armor wire 40 extruded with a thin layer of polymer 50, such as Tefzel or other polymer, that is acid resistant (e.g., FIGS. 9A through 9C). This extrusion process may be performed prior the cladding process. Then, the high acid resistant alloy 48 may be cladded over the extruded GIPS armor wire 40. The thin layer of polymer 50 extruded over the GIPS armor wire 40 is an additional barrier of acid protection if pin holes are present in the cladded alloy 48.

In certain embodiments, polymer extrusion layers may be used as the core jacket 46, the intermediate jacket layer 42 between first pass armor layer and second pass armor layer, and the final outer jacket 44. When manufacturing the cable 18, the armor wires 38 forming the inner armor layer 30, which have no cladding, may first be embedded into a polymer matrix for protection. Thereafter, the cladded outer armor wires 40 may be arranged around the inner armor layer 30, thus forming the outer armor layer 32.

Therefore, the embodiments described above with respect to FIGS. 2A through 9B include wireline cables 18 with armor wires 38, 40 comprised of alloy armor wire materials such as C-276, Inconel 686, Inconel 20, Inconel 625, Inconel 825, Incoloy 27-7MO, HC265, C-276, and/or MP35N as strength members to be used in acid and sour applications in an oilfield. In general, such cables are fully qualified for sour environments such as per NACE Level VII.

The embodiments described herein also provide wireline cables 18 with an outer jacket 44 of polymer to protect the armor wires 38, 40 from the acid environment. In such embodiments, the outer jacket 44 may have a thickness of 0.005 inch to 0.100 inch.

The embodiments described herein also include using an intermediate jacket layer 42 between the two armor layers 30, 32 of armor wires 38, 40 to maintain a minimum separation between the armor wires 38, 40, hence preventing the inner armor wire 38 to be exposed to acid attack. This enables the use of GIPS or lower cost alloys for the inner armor wire 38 to lower the cost of the cable 18.

The embodiments described herein also include the use of a polymer doped with chopped fibers 3 to 15% concentration to act as a free radical acceptor at above room temperature, which will allow a polymer jacket layer 50 to withstand higher concentrations of acids like hydrochloric acid, hydrogen sulfide, and sulfuric acid.

The embodiments described herein also include the use of acid resistant cladded outer armor wires 40 for wireline cable technology. Acid resistant alloy 48 with a thickness of 0.001 inch to 0.010 inch may also be cladded directly to GIPS armor wire 40. Alternatively, GIPS armor wires 40 may first be extruded with a thin layer of polymer jacket 50 like Tefzel or any other polymer that is acid resistant and then the high acid resistance alloy 48 may be cladded over the extruded GIPS armor wire 40.

As described in greater detail herein, wireline cables 18 are used in various well completion and intervention operations. Specifically, during perforating or fracking jobs, it is not uncommon for untreated, produced fluid with acids to be used. In many intervention operations, multiple different acids formulations are used while the cable 18 is in the well 14. While using these fluids may lower operational costs, the acid poses a threat to the life expectancy of the cable 18. This trend of using fluids with acid during operations suggests that a new approach is needed in the materials and design of wireline cables 18 when acid is expected to be present during operations.

As also described herein, wireline cables used in non-acidic environments are usually composed of copper conductor(s), polymer isolation, and two contra-helically applied layers of galvanized steel wire. Depending on the cable design, some of these wireline cables may also include a polymer jacket in between the two layers of steel wire and can include a polymer jacket on the outer surface of the cable. Through wear and tear during field operations, the cable's outer jacket can be partially removed from the cable or torn, which exposes the outer armor layer of steel wire to well fluids and the well environment. GIPS wire is not designed to withstand exposure to acid, so when acidic produced fluids are used and the outer GIPS wires are exposed to it, the cable is at risk of parting or breaking. The risk increases if the acidic fluid is also able to reach and corrode the inner armor layer of GIPS wire.

As such, the embodiments described herein provide various methods for developing an armor package (otherwise referred to as the armor packaging 28 herein) for a wireline cable 18 that can withstand acidic well fluids. It should be noted that, in all of the embodiments described above, the core 36 of the cable 18 may be gas blocked or non-filled. The armor package (e.g., the inner and outer armor layers 30, 32 of the armor packaging 28) may be isolated from the core 36 through polymer layers. Also, both armor layers 30, 32 may also be isolated from each other to prevent fluid ingression in all of the embodiments described herein. As described herein, in certain embodiments, the outer armor wires 40 may or may not have an outer jacket 44. In addition to the armor package 28 designs presented herein, use of acid neutralizing grease for operations during POOH may further protect the cable 18 from corrosion.

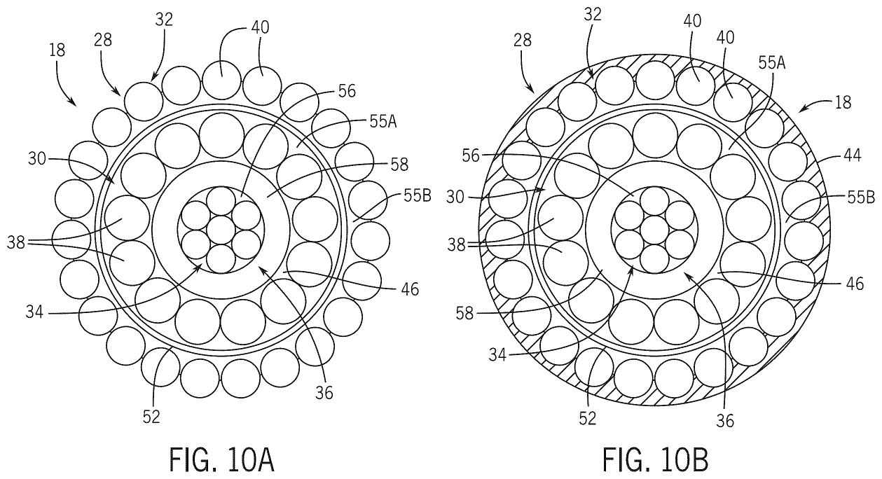

FIGS. 10A and 10B illustrate embodiments of a cable 18 that includes a GIPS inner armor layer 30, an alloy outer armor layer 32, a core polymer jacket layer 46 disposed within and adjacent the inner armor layer 30, intermediate Tefzel jacket layers 55A, 55B adjacent and between the inner armor wires 38 of the inner armor layer 30 and the outer armor wires 40 of the outer armor layer 32, and an acid isolation polymer layer 52 disposed radially between the inner armor layer 30 and the outer armor layer 32. This construction of the armor packages 28 illustrated in FIGS. 10A and 10B is designed to ensure that the gaps adjacent and between the armor wires 38, 40 are sealed with the layers 52, 55. For example, as illustrated in FIGS. 10A and 10B, in certain embodiments, the core polymer jacket layer 46 may be disposed radially between the inner armor wires 38 of the inner armor layer 30 and the core 36 of the cable 18, a first intermediate Tefzel jacket layer 55A disposed between the inner armor wires 38 of the inner armor layer 30 and the acid isolation polymer layer 52, and a second intermediate

Tefzel jacket layer 55B disposed between the acid isolation polymer layer 52 and the outer armor wires 40 of the outer armor layer 32 (e.g., such that the first and second intermediate Tefzel jacket layers 55A, 55B are disposed on both sides of the acid isolation polymer layer 52). As such, in such embodiments, the acid isolation polymer layer 52 may be disposed between the first and second intermediate Tefzel jacket layers 55A, 55B.

In certain embodiments, the acid isolation polymer layer 52 may be made from PEEK, PFA, any polyketone, or any other suitable polymer. As such, to prevent any fluids from penetrating the armor package 28 and come into contact with the inner armor wires 38, the acid isolation polymer layer 52 composed of polymer, as described above, may be applied radially within the second intermediate Tefzel jacket layer 55B. This acid isolation barrier layer 52 ensures that the inner armor wires 38 are protected from corrosive well fluids. Additionally, in certain embodiments such as illustrated in FIG. 10B, an outer jacket 44 may be layered on top of the acid isolation polymer layer 52 (e.g., radially around the second intermediate Tefzel jacket layer 55) to occupy any remaining voids within this outer jacket 44. In this embodiment, the outer armor wires 40 may be one of the alloy materials discussed herein (e.g., Inconel 625, Inconel 825, Incoloy 27-7MO, HC265, C-276, MP35N, or any other suitable alloys).

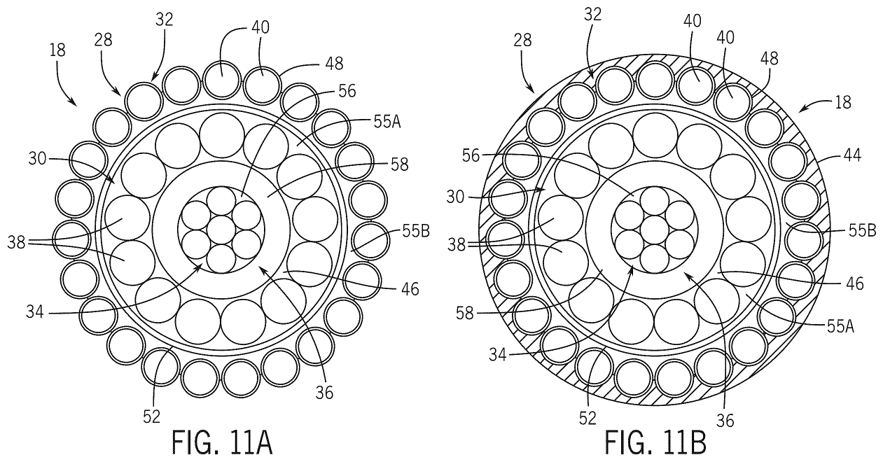

The outer armor wires 40 may or may not be jacketed, as described in greater detail herein. For example, FIGS. 11A and 11B illustrate embodiments of a cable 18 that includes a GIPS inner armor layer 30, a GIPS outer armor layer 32 having alloy cladded outer armor wires 40 (e.g., cladded with an acid resistant alloy 48, similar to the embodiments illustrated in FIGS. 8A through 9C), a core polymer jacket layer 46 disposed within and adjacent the inner armor layer 30, intermediate Tefzel jacket layers 55A, 55B adjacent and between the inner armor wires 38 of the inner armor layer 30 and the alloy cladded outer armor wires 40 of the outer armor layer 32, and an acid isolation polymer layer 52 disposed radially between the inner armor layer 30 and the outer armor layer 32. The embodiments illustrated in FIGS. 11A and 11B are substantially similar to the embodiments illustrated in FIGS. 10A and 10B otherwise. In certain embodiments, the acid isolation polymer layer 52 may be made from PEEK, PFA, any polyketone, or any other suitable polymer.

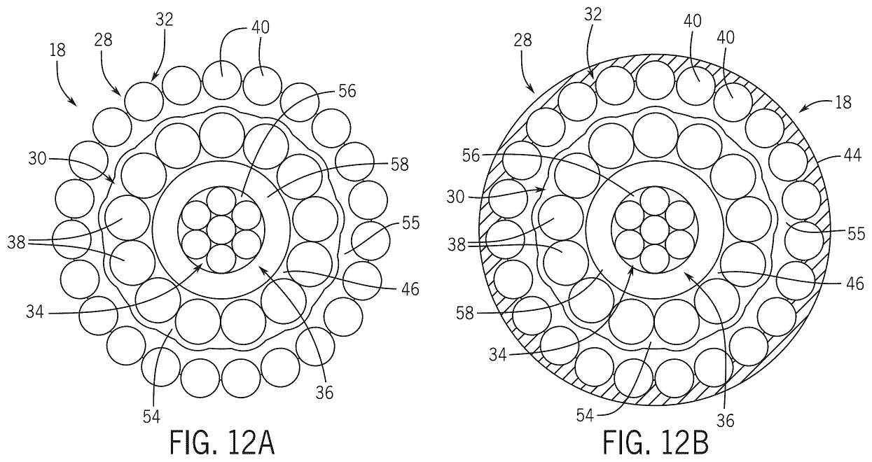

FIGS. 12A and 12B illustrate embodiments of a cable 18 that includes a GIPS inner armor layer 30, an alloy outer armor layer 32, a core polymer jacket layer 46 disposed within and adjacent the inner armor layer 30, an acid isolation polymer layer 54 formed through extrusion around the inner armor layer 30, and a single intermediate Tefzel jacket layer 55 adjacent and between the acid isolation polymer layer 54 and the outer armor wires 40 of the outer armor layer 32. This construction of the armor packages 28 illustrated in FIGS. 12A and 12B is designed to ensure that the gaps adjacent and between the armor wires 38, 40 are sealed with the layers 52, 55 and the extruded acid isolation polymer layer 54. In certain embodiments, the acid isolation polymer layer 54 may be made from PEEK, PFA, any polyketone, or any other suitable polymer.

As such, to prevent any fluids from penetrating the armor package 28 and come into contact with the inner armor wires 38, an acid isolation polymer layer 54 of PEEK, PFA, any polyketone, or any other suitable polymer, as described above, may be applied over the inner armor wires 38. This acid isolation polymer layer 54 ensures that the inner armor wires 38 are protected from corrosive well fluids. Additionally, in certain embodiments such as illustrated in FIG. 12A, an outer jacket 44 may be layered on top of the acid isolation polymer layer 54 (e.g., radially around the single intermediate Tefzel jacket layer 55) to occupy any remaining voids within this outer jacket 44. In this embodiment, the outer armor wires 40 may be one of the alloy materials discussed herein (e.g., Inconel 625, Inconel 825, Incoloy 27-7MO, HC265, C-276, MP35N, or any other suitable alloys).

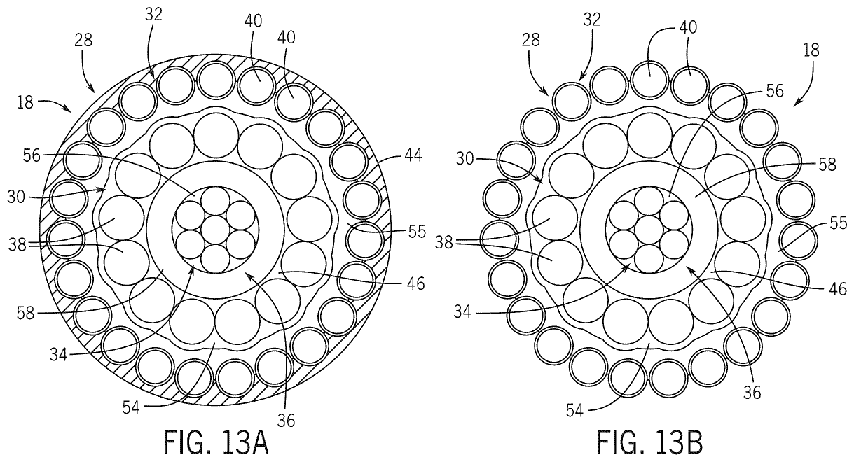

The outer armor wires 40 may or may not be jacketed, as described in greater detail herein. For example, FIGS. 13A and 13B illustrate embodiments of a cable 18 that includes a GIPS inner armor layer 30, an alloy outer armor layer 32 having alloy cladded outer armor wires 40 (e.g., cladded with an acid resistant alloy 48, similar to the embodiments illustrated in FIGS. 8A through 9C), a core polymer jacket layer 46 disposed within and adjacent the inner armor layer 30, an acid isolation polymer layer 54 formed through extrusion around the inner armor layer 30, and a single Tefzel jacket layer 55 adjacent and between the acid isolation polymer layer 54 and the alloy cladded outer armor wires 40 of the outer armor layer 32. The embodiments illustrated in FIGS. 13A and 13B are substantially similar to the embodiments illustrated in FIGS. 12A and 12B otherwise.

Each of the cable embodiments illustrated in FIGS. 2A through 13B may include slight alternative designs than the designs illustrated. For example, in certain embodiments, as best illustrated in FIGS. 10A through 13B, the space 56 between the stranded central conductor 34 and a core jacket 58 of the core 36 may either be gas blocked (e.g., where the space 56 between the stranded central conductor 34 and the core jacket 58 of the core 36 are filled) or not gas blocked (e.g., where the space 56 between the stranded central conductor 34 and the core jacket 58 of the core 36 are not filled).

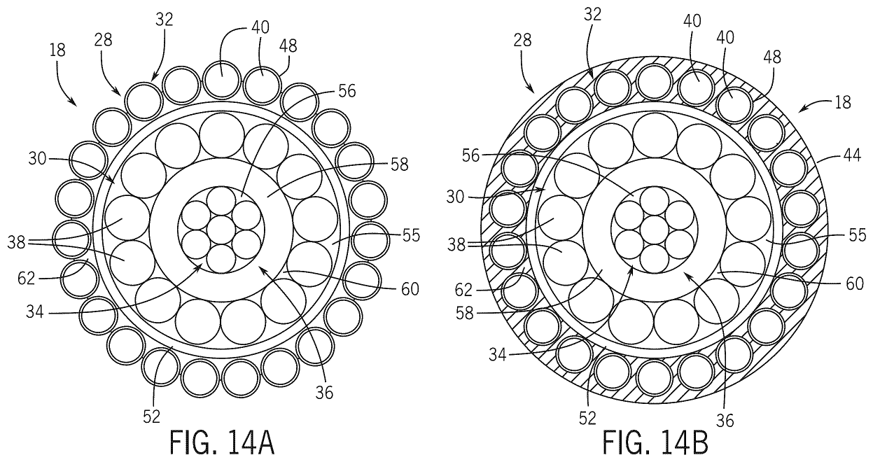

In addition, in certain embodiments, voids may exist between certain armor wires 38, 40. For example, as illustrated in FIGS. 14A and 14B, in certain embodiments, voids 60 may exist between the core 36 of the cable 18 and the inner armor wires 38 of the inner armor layer 30 of the cable 18. In addition, in certain embodiments, voids 62 may exist between the outer armor wires 40 of the outer armor layer 32 of the cable 18 and the acid isolation polymer layer 52 of the cable 18. Indeed, voids may exist between the armor wires 38, 40 of the armor layers 30, 32 and any other components of the cable 18 against which the armor wires 38, 40 directly abut (e.g., in any and all of the other embodiments described herein). For example, in certain embodiments, neither of the intermediate Tefzel jacket layers 55 may be utilized adjacent and between the core 36 of the cable 18 and the inner armor wires 38 of the inner armor layer 30 of the cable 18.

Indeed, any and all possible combinations of the components of the embodiments of the cables 18 described herein may be used in combination with each other in other embodiments. As but one non-limiting example, in certain embodiments, the inner armor wires 38 of the inner armor layer 30 of the cable 18 may also be surrounded by an acid resistance alloy 48 and/or a polymer jacket layer 50, similar to the outer armor wires 40 of the outer armor layer 32 of the cable 18 illustrated in FIGS. 8A through 9B. Moreover, some of the components of each of the embodiments of the cables 18 described herein may be omitted from other embodiments.

In certain embodiments, some or all of the armor wires 38, 40 of the cable 18 (although, in certain embodiments, only the outer armor wires 40 to save costs) may be coated with an acid protecting chemical coating to zinc, alloy or bare steel armor wires without any jacket. The chemical coating may be or include any of the following: organic nitrogen compounds such as amines, amides, heterocyclics, and quaternary ammonium salts, intensifiers such as formic acid, iodides, and acid-soluble salts of copper, bismuth, antimony, and mercury with compound groups such as alpha hydroxy acetylene, alkenyl phenones and cinnamaldehyde derivatives.

As such, the embodiments described herein provide for cost-effective wireline cables 18 that can withstand acidic fluid environment by providing an acid isolation polymer layer 52, 54 between inner and outer armor wires 38, 40 of the cables 18. In certain embodiments, the outer armor wires 40 may be made of one or more of the alloy materials discussed herein (e.g., Inconel 625, Inconel 825, Incoloy 27-7MO, HC265, C-276, MP35N, or any other suitable alloys). In addition, in certain embodiments, the outer armor wires 40 may be GIPS cladded with one or more of the alloy materials discussed herein (e.g., Inconel 625, Inconel 825, Incoloy 27-7MO, HC265, C-276, MP35N, or any other suitable alloys). In addition, in certain embodiments, an outer jacket 44 may be put over the acid isolation polymer layer 52, 54 to further increase the resistance to acid. In addition, in certain embodiments, the core 36 of the cable 18 may be gas blocked. In addition, in certain embodiments, the inner armor wires 38 may be embedded into the core jacket 58 of the core 36 of the cable 18 to reduce fluid migration. In addition, in certain embodiments, during POOH, the cable 18 may be greased with acid neutralizing grease either at the PCE (pressure control equipment) or at the wireline drum.

In addition, the embodiments described herein provide for cost-effective wireline cables 18 that can withstand acidic fluid environment by providing acid isolation with a smooth jacketed cable. In certain embodiments, the outer armor wires 40 of the cable 18 may be made of one or more of the alloy materials discussed herein (e.g., Inconel 625, Inconel 825, Incoloy 27-7MO, HC265, C-276, MP35N, or any other suitable alloys). In addition, in certain embodiments, the outer armor wires 40 may be GIPS cladded with one or more of the alloy materials discussed herein (e.g., Inconel 625, Inconel 825, Incoloy 27-7MO, HC265, C-276, MP35N, or any other suitable alloys). In addition, in certain embodiments, an outer jacket 44 may be put over the acid isolation polymer layer 52, 54 to further increase the resistance to acid. In addition, in certain embodiments, the core 36 of the cable 18 may be gas blocked. In addition, in certain embodiments, the inner armor wires 38 may be embedded into the core jacket 58 of the core 36 of the cable 18 to reduce fluid migration. In addition, in certain embodiments, during POOH, the cable 18 may be greased with acid neutralizing grease either at the PCE (pressure control equipment) or at the wireline drum.

In addition, the embodiments described herein provide for wireline cables where some or all of the armor wires 38, 40 (although, in certain embodiments, only the outer armor wires 40 to save costs) may be coated in an acidic protective inhibition chemical like organic nitrogen compounds such as amines, amides, heterocyclics, and quaternary ammonium salts, intensifiers such as formic acid, iodides, and acid-soluble salts of copper, bismuth, antimony, and mercury with compound groups such as alpha hydroxy acetylene, alkenyl phenones and cinnamaldehyde derivatives. In certain embodiments, the outer armor wires 40 of the cable 18 may be made of one or more of the alloy materials discussed herein (e.g., Inconel 625, Inconel 825, Incoloy 27-7MO, HC265, C-276, MP35N, or any other suitable alloys). In addition, in certain embodiments, the outer armor wires 40 may be GIPS cladded with one or more of the alloy materials discussed herein (e.g., Inconel 625, Inconel 825, Incoloy 27-7MO, HC265, C-276, MP35N, or any other suitable alloys). In addition, in certain embodiments, an outer jacket 44 may be put over the acid isolation polymer layer 52, 54 to further increase the resistance to acid. In addition, in certain embodiments, the core 36 of the cable 18 may be gas blocked. In addition, in certain embodiments, the inner armor wires 38 may be embedded into the core jacket 58 of the core 36 of the cable 18 to reduce fluid migration. In addition, in certain embodiments, during POOH, the cable 18 may be greased with acid neutralizing grease either at the PCE (pressure control equipment) or at the wireline drum. In addition, in certain embodiments, an acid isolation polymer layer 52, 54 may be present between the two armor layers 30, 32.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. § 112(f). However, for any claims containing elements designated in any other manner, it is intended that such elements are not to be interpreted under 35 U.S.C. § 112(f).

1. An armor packaging for a cable, comprising:
an inner armor layer and an outer armor layer, the outer armor layer formed by armor wires made from alloy materials with higher acid resistance than armor wires of the inner armor layer.

2. The armor packaging of claim 1, wherein outer armor wires of the outer armor layer are made of Inconel 625, Inconel 825, Incoloy 27-7MO, HC265, C-276, or MP35N.

3. The armor packaging of claim 1, wherein outer armor wires of the outer armor layer are made of galvanized improved plow steel (GIPS) cladded with an alloy material.

4. The armor packaging of claim 3, wherein the alloy material comprises Inconel 625, Inconel 825, Incoloy 27-7MO, HC265, C-276, or MP35N.

5. The armor packaging of claim 1, comprising an outer jacket radially surrounding the outer armor layer.

6. The armor packaging of claim 5, wherein the outer jacket is made of an acid resistant polymer.

7. The armor packaging of claim 1, comprising an intermediate layer disposed radially between the inner armor layer and the outer armor layer.

8. The armor packaging of claim 7, wherein the intermediate layer is made of an acid resistant polymer.

9. The armor packaging of claim 1, wherein outer armor wires forming the outer armor layer are cladded with an acid-resistant alloy.

10. The armor packaging of claim 9, comprising a polymer layer disposed radially between each outer armor wire and its respective acid-resistant alloy cladding.

11. The armor packaging of claim 1, wherein each of the armor wires of the outer armor layer are generally round in shape.

12. The armor packaging of claim 1, wherein each of the armor wires of the outer armor layer are generally non-round in shape.

13. The armor packaging of claim 1, wherein each of the armor wires of the outer armor layer are comprised of a plurality of armor wire strands bundled together to form the respective armor wire.

14. A wireline cable comprising:
an armor packaging comprising:
an inner armor layer and an outer armor layer, the outer armor layer formed by armor wires made from alloy materials with higher acid resistance than armor wires of the inner armor layer; and
an acid isolation polymer layer disposed radially between the inner armor layer and the outer armor layer.

15. The wireline cable of claim 14, wherein outer armor wires of the outer armor layer are made of galvanized improved plow steel (GIPS) cladded with a cladding alloy material.

16. The wireline cable of claim 14, comprising:
a first intermediate Tefzel jacket layer disposed radially between the inner armor layer and the acid isolation polymer layer; and
a second intermediate Tefzel jacket layer disposed radially between the acid isolation polymer layer and the outer armor layer.

17. The wireline cable of claim 14, wherein the acid isolation polymer layer is extruded around the inner armor layer, and wherein the wireline cable comprises an intermediate Tefzel jacket layer disposed radially between the acid isolation polymer layer and the outer armor layer.

18. The wireline cable of claim 14, wherein a core of the wireline cable that encompasses one or more electrical conductors of the wireline cable is gas blocked.

19. The wireline cable of claim 14, wherein a core of the wireline cable that encompasses one or more electrical conductors of the wireline cable is not gas blocked.

20. The wireline cable of claim 14, comprising voids between the inner armor layer and a core of the wireline cable that encompasses one or more electrical conductors of the wireline cable.

21. The wireline cable of claim 14, comprising voids between the outer armor layer and the acid isolation polymer layer.

22. A wireline cable comprising:
an armor packaging comprising an inner armor layer and an outer armor layer, wherein inner armor wires forming the inner armor layer and/or outer armor wires forming the outer armor layer are coated with an acidic protective inhibition chemical selected from the group of:
organic nitrogen compounds including amines, amides, heterocyclics, and quaternary ammonium salts; and
intensifiers including formic acid, iodides, and acid-soluble salts of copper, bismuth, antimony, and mercury with compound groups including alpha hydroxy acetylene, alkenyl phenones, and cinnamaldehyde derivatives.
